(19) United States
(12) Patent Application Publication
(10) Pub. No.: US 2019/0063646 A1
(43) Pub. Date: Feb. 28, 2019

(54) CONNECTING CLAMP

(71) Applicant: Mahle International GmbH, Stuttgart (DE)

(72) Inventors: Alexander Bopp, Illingen (DE); Walter Kreuzer, Leonberg (DE); Werner Rauland, Pforzheim (DE); Dieter Sartorius, Vaihingen Enz (DE); Oliver Schultze, Stuttgart (DE); Walter Wolf, Oppenweiler-Zell (DE)

(21) Appl. No.: 16/115,523

(22) Filed: Aug. 28, 2018

(30) Foreign Application Priority Data
Aug. 30, 2017 (DE) 102017215157.9

(51) Int. Cl. F16L 23/00; F16L 41/08

(52) U.S. Cl. CPC F16L 23/003; F16L 41/08

(57) ABSTRACT

A connecting clamp for connecting two pipe stubs with an associated pipe body may include a first clamp body for connecting a first pipe stub with a first pipe body and a second clamp body disposed spaced apart from the first clamp body for connecting a second pipe stub with a second pipe body. The connecting clamp may also include a connecting body arranged between the clamp bodies. The connecting body may pivotably connect the clamp bodies with one another such that the clamp bodies are pivotable relative to one another between a start pivot position and an end pivot position. The connecting body may include a fixing device for fixing the clamp bodies in the end pivot position.

### CROSS-REFERENCE TO RELATED APPLICATIONS

This application claims priority to German Patent Application No. DE 10 2017 215 157.9, filed on Aug. 30, 2017, the contents of which are hereby incorporated by reference in its entirety.

### TECHNICAL FIELD

The present invention relates to a connecting clamp for connecting two pipe stubs with an associated pipe body each. The invention, furthermore, relates to a heat exchanger having such a connecting clamp.

### BACKGROUND

In a multiplicity of applications it is necessary to connect pipes with one another, in particular a pipe stub with a pipe body.

DE 10 2014 200 906 A1 proposes to form a pipe stub elastically in order to establish a connection between the pipe stub and an associated pipe body. Such a type of the connection between pipe stub and pipe body however requires an expensive manufacture of the individual component parts and/or is susceptible.

DE 10 2013 212 629 A1 as well as DE 10 2015 204 982 A1 propose a clamp-like connecting element for connecting a pipe body with a pipe stub, which connecting element is arranged about the associated pipe stub and pipe body and clamped together. In order to secure the connecting element in the clamped position, these documents propose a positively locked connection of legs moulded on the connecting element. Using such connecting elements results in a comparatively expensive assembly which is amplified in that in a multiplicity of applications, multiple pipe stubs have to be connected with associated tube bodies in each case so that for the respective connection such a separate connecting element is employed.

For reducing the assembly expenditure, DE 699 057 80 T2 provides employing a connecting clamp which consists of parts that are separate of one another, which are connected to one another by means of a screw connection and in the connected state form two clamps which in each case connect a pipe stub with an associated pipe body. A similar solution is proposed by DE 1 625 350 A. In the of these connecting clamps, the separate attaching of the separate parts of the connecting clamp to the pipe stubs and the pipe bodies and the subsequent connecting of the parts by means of the screws is always necessary so that the assembly is again rendered more difficult.

EP 1 607 709 A2 proposes a flange with two flange halves each of which can connect a pipe stub with a pipe body, wherein the flange halves are axially pluggable into one another. For fastening the respective pipe stub with the associated pipe, the respective flange half thus has to be initially plugged axially onto the associated pipe stub and the flange halves additionally axially plugged into one another, so that the assembly expenditure is again comparatively major.

### SUMMARY

The present invention therefore deals with the object of stating for a connecting clamp for connecting two pipe stubs each with an associated pipe body improved or at least other embodiments or a heat exchanger with two pipe stubs and two associated pipe bodies, which are particular by a simplified construction and/or a reduced expenditure of the assembly for fastening the pipe stubs with the pipe bodies.

According to the invention, this object is solved through the subject[[s]] matter of the independent claim(s). Advantageous embodiments are subject matter of the dependent claim(s).

The present invention is based on the general idea of providing a connecting clamp for connecting two pipe stubs each with an associated pipe body with two clamp bodies and a connecting body connecting the clamp bodies, wherein the connecting body moveably connects the clamp bodies with one another and fixes the same in a predetermined position relative to one another. By way of this, the connecting clamp is continuous and can accordingly be attached to the respective associated pipe stubs and pipe bodies in a simplified manner, so that the assembly of the connecting clamp on the pipe stubs and the pipe bodies takes place in a simplified manner. The assembly is further simplified by the connecting body through the connection of the clamp bodies that is moveable relative to one another. The fixing of the clamp bodies of the connecting body relative to one another results in a further simplification of the assembly and a simplified fixing of the connecting clamp on the associated pipe bodies and pipe stubs. Altogether, the connecting clamp is thus configured simply and can be attached and fixed to the pipe stubs and the pipe bodies in a simple and reliable manner.

According to the inventive idea, the connecting clamp comprises the clamp bodies that are spaced from one another, namely a first clamp body and a second clamp body, wherein the first clamp body serves for connecting a first pipe stub with a first pipe body and the second clamp body for connecting a second pipe stub with a second pipe body. The connecting body moveably connects the two clamp bodies. The connection of the clamp bodies that is moveable relative to one another is configured with the help of the connecting body in such a manner that the clamp bodies are pivotable relative to one another between a starting pivot position and an end pivot position. For fixing the clamp bodies relative to one another, the connecting body additionally comprises a fixing device, which fixes the clamp bodies in the end pivot position relative to one another. This means that the fixing device fixes the clamp bodies in the end pivot position in such a manner that they can no longer be pivoted relative to one another.

Preferably, the fixing device is configured in such a manner that the relative fixing of the clamp bodies in the end pivot position can be disengaged. As a consequence, the clamp bodies following the disengagement can be again pivoted relative to one another in such a manner that at least one of the clamp bodies can be disengaged from the associated pipe stub and/or pipe body.

Preferred are embodiments, with which the connecting body, in particular the fixing device, is configured in such a manner that the clamp bodies are exclusively fixed relative to one another in the end pivot position. In other words, outside the end pivot position, the clamp bodies can be pivoted relative to one another wherein they can assume and pass through any pivot positions between the start pivot position and the end pivot position. This simplifies the assembly of the connecting clamp on the pipe stubs and the pipe bodies.

Directed away from one another, the clamp bodies are advantageously open in the end pivot position. This allows a simplified mounting of the connecting clamp to the pipe stubs and the pipe bodies and/or renders unintentional disengaging of the clamp bodies out of the end pivot position more difficult.

In principle, the clamp bodies and the connecting bodies can each be produced separately and subsequently connected with one another.

Preferred are embodiments, in which the clamp bodies and the connecting bodies are produced in one piece, in particular of uniform material or monolithically. In this way, the connecting clamp can be easily and cost-effectively produced. In addition, attaching the connecting clamp to the pipe stubs and pipe bodies, in the following also called attaching in brief, can thus be simplified. Here it is conceivable to produce the connecting clamp by a casting method, in particular by an injection moulding method. This means that the clamp bodies and the connecting bodies are produced by a common casting method, in particular injection moulding method. Here, the connecting clamp can be produced in particular from plastic. In this way, the connecting clamp can be cost-effectively and/or easily produced.

Preferred are embodiments, in which the respective clamp body is radially pluggable onto the associated pipe stub or pipe body and the respective clamp body is pivotable about an axially extending pivot axis. As a consequence, a particularly simple attaching of the clamp body to the associated pipe stub or pipe bodies and a particularly simplified pivoting of the clamp bodies relative to one another and a particularly simple fixing of the clamp bodies in the end pivot position can be realised. Here, the respective clamp body can be pivotable about an associated pivot axis. It is preferred if both clamp bodies are pivotable about a common pivot axis.

Embodiments, in which the connecting body defines a pivot axis, in particular the abovementioned common pivot axis, about which the clamped bodies are pivotable, prove to be advantageous. This means in particular that the pivot axis is formed by the connecting body and/or extends through the connecting body. This results in a simplified configuration of the connecting clamp and/or in a simplified mounting of the connecting clamp. Here, the pivot axis is not necessarily a mechanical axis, in particular not necessarily a shaft. Here it is preferred when the pivot axis is arranged between the clamp bodies, in particular spaced from these. Thus, the pivoting of the respective clamp body can be realised in a greater pivot range and/or more independently of the other clamp body.

In principle, the fixing device can be configured in any way provided it allows a fixing of the clamp bodies relative to one another in the end pivot position.

Preferably the fixing device is configured in such a manner that it fixes the clamp bodies relative to one another during the adjusting in the end pivot position. This means that for fixing in the end pivot position, no further measures except the pivoting of the clamp bodies into the end pivot position are necessary. This results in a substantially simplified mounting and fixing of the clamp bodies to the associated pipe stubs and pipe bodies.

It is conceivable to provide the fixing device with a first fixing element, which is attached on the first clamp body and a second fixing element, which is attached on the second clamp body, wherein the fixing elements interact in the end pivot position for fixing the clamp bodies.

Embodiments, in which the fixing elements in the end pivot position are connected to one another through a positively locked connection, in particular by an engagement connection, in such a manner that they secure or fix the clamp bodies against a disengaging out of the end pivot position are considered advantageous. Here it is advantageous when the positively locked connection is established during the pivoting of the clamp bodies into the end pivot position, so that no additional measures for establishing the positively locked connection are necessary.

For securing the clamp bodies against a disengaging out of the end pivot position it is alternatively or additionally conceivable that the clamp bodies are preloaded against one another in the end pivoted position.

Preferred embodiments provide that the respective clamp body in a plan view, in particular in an axial plan view, is designed U-shaped and comprises a long leg and a short leg. Such a design of the clamp bodies allows the simplified mounting of both clamp bodies on the respective associated pipe stub or pipe body. By way of this, the radial plugging of the respective clamp body is clearly simplified in particular. The pivoting of the respective clamp body in the radially plugged state is likewise substantially simplified. In addition, the long legs and the short legs can thereby be each arranged in a common plane, which results in a reliable connection of the respective pipe stub with the associated pipe body and/or an improved securing of the clamp bodies against disengaging out of the end pivot position.

It is additionally advantageous when the long legs of both clamp bodies are arranged on a first side of the connecting body and the short legs of both clamp bodies are arranged on a second side of the connecting body facing away from the first side. The said sides are advantageously arranged transversely to the connecting direction of the clamp bodies and/or transversely to the radial plugging direction of the clamp bodies.

In principle, the connecting body can pivotably connect the clamp bodies with one another in any way. In particular, the connecting body can comprise a joint or a shaft for this purpose.

Advantageously, the connecting body comprises a hinge which pivotably connects the clamp bodies with one another. Thus, the connecting body can be easily and cost-effectively produced in particular by a moulding method. Here, the hinge is not necessarily a film hinge.

Preferred are embodiments, in which the hinge is attached on at least one of the fixing elements and thus pivotably connects the clamp body that is attached or fixed to this fixing element with the other clamp body. Advantageously, the hinge is only attached on one of the fixing elements, in particular on the second fixing element and additionally connected with the other clamp body, in particular with the first clamp body, by a rigid connecting element. Thus it is possible, in particular, to at least partly decouple the pivoting of the clamp bodies relative to one another and the fixing in the end pivot position from one another. This allows not employing the possibly mechanically less stable pivotable realisation of the connecting body, in particular the hinge, or at least to a reduced degree, for fixing in the end pivot position. In the result, the clamp bodies can thus be pivoted relative to one another in a simplified manner and render the fixing with the help of the fixing device mechanically more stable.

In an advantageous embodiment, the first fixing element is a stem projecting from the first clamp body with a projecting engagement structure, while the second fixing element is a seating. During the adjusting of the clamp bodies into the end pivot position, the engagement structure of the stem engages in the seating and thus connects the fixing elements in a positively locked manner so that the clamp bodies are fixed and secured in the end pivot position. Here, the engagement structure can engage in particular in the seating, i.e. in particular be an engagement element of an engagement lug.

Preferred are embodiments, in which the fixing elements strike against one another in the end pivot position in such a manner that a further pivoting of the clamp bodies beyond the end pivot position is blocked or at least rendered more difficult. This results in a reduced loading of the connecting body, in particular of the hinge, and a simplified mounting of the connecting clamp. In addition, a fitter during the attaching of the connecting clamp receives a haptic and/or acoustic feedback as to when the end pivot position is reached. The stop of the fixing elements can be realised in particular with the help of the said stem and the seating in such a manner that the stem strikes a stop in the seating.

In advantageous forms of embodiment at least one of the clamp bodies, advantageously both clamp bodies, have a U-shaped cross-section to grip around a section of the associated pipe stub or pipe body projecting radially on the outside. This allows reliable connection of the pipe stub to the pipe body. In addition the clamp body can be more simply mounted on the pipe stub and/or the pipe body, in particular radially.

The radially projecting section of the associated pipe body or pipe stub can, in particular, be a flange and/or a compression.

In principle it is conceivable to arrange the clamp bodies in different planes, which are, in particular, axially offset. Preferred are forms of embodiment in which the clamp bodies are arranged in a common plane, wherein the pivoting axis is perpendicular to this plane. It is also preferred if the connecting bodies are also arranged in this plane. In this way the connecting clamp, in particular the respective clamp body, can also be applied more simply to the pipe stubs and the associated pipe body in the case of small available spaces.

In principle the connecting clamp can be used in any application for connecting the pipe stubs to the respectively associated pipe body. In particular the connecting clamp can be used in a heat exchanger in order to connect pipe stubs of the heat exchanger, which are used to supply fluid to the heat exchanger, to the respectively associated pipe.

More particularly the pipe stubs can be arranged and project from a collection container of the heat exchanger. It is also conceivable that the respective pipe stub is plugged into the associated pipe body, wherein the connecting clamp secures the respective plug connection and thus connects both pipe stubs to the respectively associated pipe body.

It is preferred if the pipe stubs of the heat exchanger are arranged at a distance from and in parallel to one another. In this way the heat exchanger can be designed in a space-saving manner and the connection of the respective pipe stub to the associated pipe body can take place by way of the connecting clamp in a space-saving and simplified manner.

It is advantageous if the respective clamp body can be rotated about a longitudinal centre axis of the associated pipe stub and/or pipe body or an axis extending in parallel thereto. This means that the first clamp body can be rotated about a longitudinal centre axis of the associated pipe stub or an axis extending in parallel to the longitudinal centre axis of the associated pipe stub and the second clamp body can be rotated about a longitudinal centre axis of the associated pipe stub or an axis extending in parallel to the longitudinal centre axis of the associated pipe stub. This rotation is also advantageously brought about by the pivoting of the respective clamp body relative to the other clamp bodies. Through this, in particular, it is possible to plug the respective clamp body radially onto the associated pipe stub and/or pipe body and to then pivot and/or rotate it about the longitudinal centre axis. In this way the application of the connecting clamp to the pipe stubs and/or the pipe bodies and fixing in the end pivot position can be carried out particularly easily.

The respective pipe stub and the associated pipe body can abut each other through such radially projecting sections on the outside. In particular it is conceivable that a compression of the pipe body abuts a flange of the pipe stub or vice versa. Such an abutment is not necessarily direct. More particularly it is conceivable that a seal is provided between the compression and the flange.

Further important features and advantages of the invention are set out in the sub-claims, the drawings and the accompanying descriptions of the figures with the aid of the drawings.

It goes without saying that the feature mentioned above and still to be mentioned below are not only applicable to the combination set out in each case, but also for other combinations or by themselves without departing from the framework of the present invention.

Preferred examples of embodiment of the invention are set out in the drawings and will be explained in more detail in the following description, wherein the same reference numbers apply to identical or similar or functionally identical components.

### BRIEF DESCRIPTION OF THE DRAWINGS

Schematically

FIG. 1 shows an isometric view of a heat exchanger with a connecting clamp,

FIG. 2 shows a cross-section through the heat exchanger in the region of the connecting clamp,

FIG. 3 shows an isometric view of the connecting clamp,

FIG. 4 shows a view from above the connecting clamp,

FIGS. 5 to 9 show successive stages of applying the connecting claim, each as a view from above,

FIG. 10 shows the view in FIG. 2 in a different example of embodiment,

FIG. 11 shows an enlarged view from FIG. 10 in a further example of embodiment.

### DETAILED DESCRIPTION

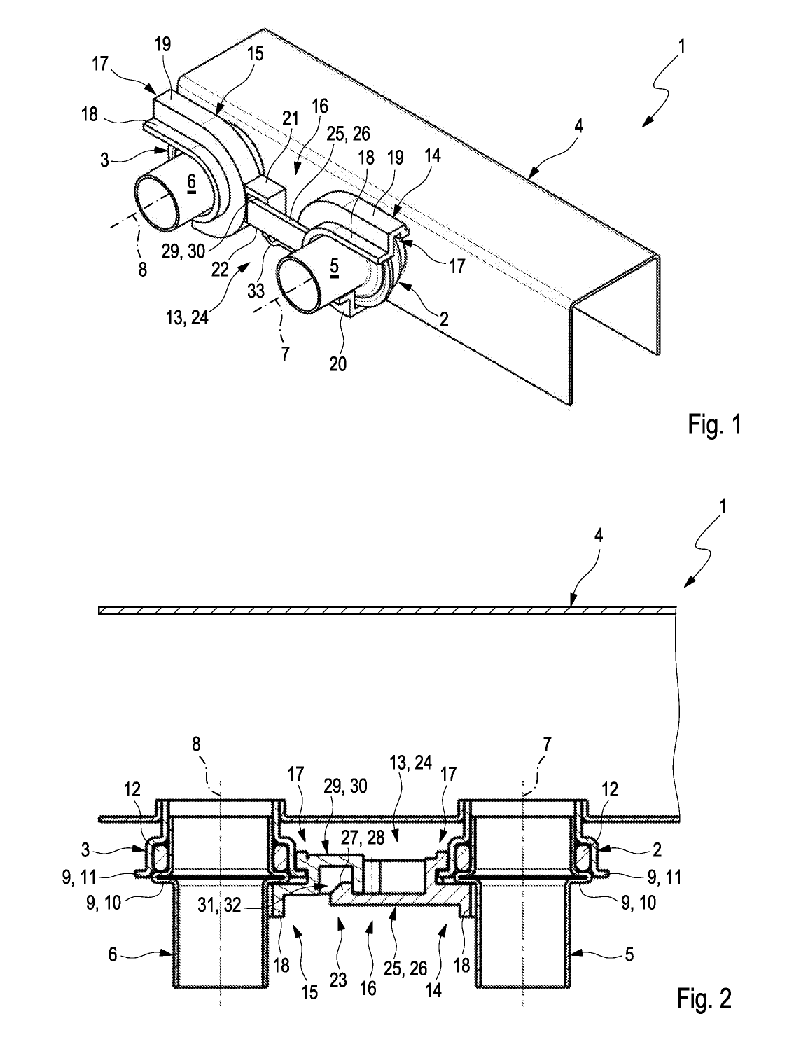

A heat exchanger 1, as shown in FIGS. 1 and 2, has two pipe stubs 2, 3 which project from the heat exchanger 1. In the shown example the pipe stubs 2, 3 project from a collection container 4 of the otherwise not shown heat exchanger 1. The collection container 4 is for collecting/distributing a fluid, for example a coolant that flows through the heat exchanger 4 when it is in operation. The pipe stubs 2, 3 are used for fluidically supplying the collection container 4 and thus the heat exchanger 1. In particular, a first pipe stub 2 can be used for supplying the fluid and a second pipe stub 3 for removing the fluid. The first pipe stub 2 is connected to a first pipe body 5 and the second pipe stub 3 to a second pipe body 6. In the shown example the pipe stubs 2, 3 are essentially identical in design, and the same applies to the pipe bodies 5, 6. The pipe stubs 2, 3 project in parallel from the collection container 4 and are at a distance from each other. Accordingly the first pipe stub 2 has a first longitudinal centre axis 7, which extends in parallel to and at distance from a second longitudinal centre axis 8 of the second pipe stub 3. In the shown examples, as can be seen in particular in FIG. 2, the respective pipe body 5, 6 is axially plugged into the associated pipe stub 2, 3.

As can be seen in particular in FIG. 2, the respective pipe stub 2, 3 and the respective pipe body 5, 6 has a radially projecting section 9 on the outside wherein radially refers to the respective associated longitudinal centre axis 7, 8. In the shown example the section 9 of the respective pipe body 5, 6 is a circumferential, radially projecting compression 10 on the outside, whereas the section 9 of the respective pipe stub 2 is a flange 11 which is formed by a radially stepped design of the pipe stub 2. The respective flange 11 forms an axial abutment for the associated compression 10, wherein a ring seal 12 is arranged between the respective compression 10 and the associated pipe stub 2.

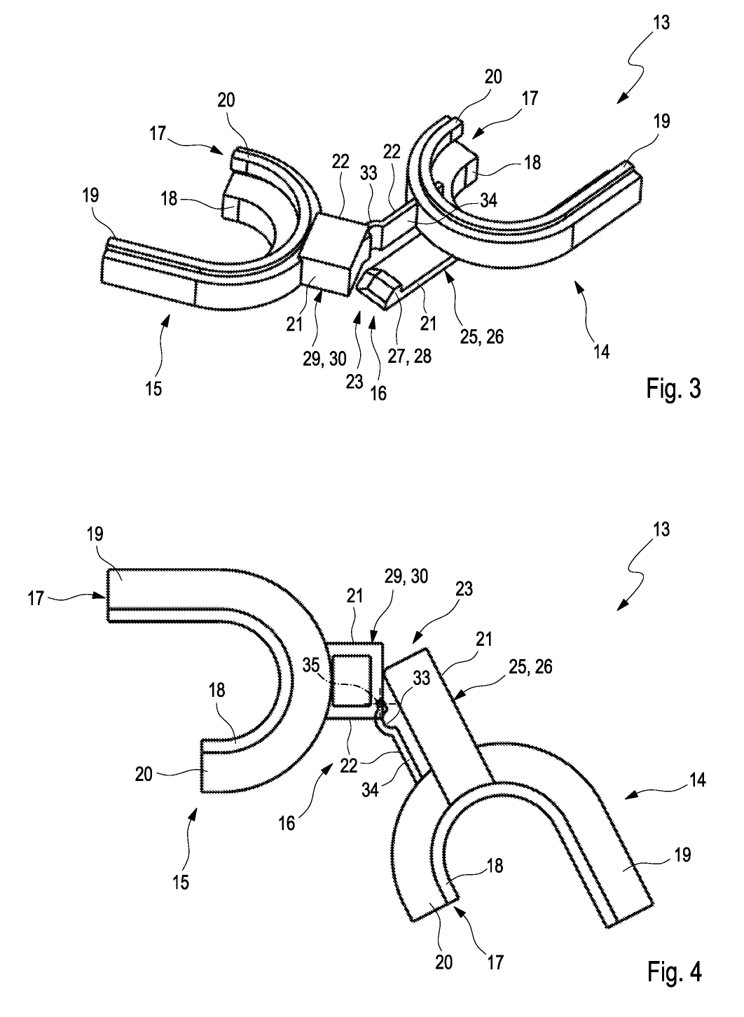

Both pipe stubs 2, 3 are detachably connected to the associated pipe body 5, 6 by means of joint connecting clamp 13 which in FIGS. 3 and 4 is shown separately in an isometric view and a view from above respectively. The connecting clamp 13 comprises a first clamp body 14 and a second clamp body 15 at a distance from the first clamp body 14. The connecting clamp 13 also has a connecting body 16 which connects the clamp bodies 14, 15 relative to each other in pivoting manner. In the shown example the clamp bodies 14, 15 and the connecting body 16 are produced in one piece or monolithically, for example of a plastic, in particular by way of a joint casting process. The first clamp body 14 radially and axially grips around the first pipe stub 2 in the region of the flange 11 and the first pipe body 5 in the region of the compression 10 so that the first pipe body 5 is secured against becoming detached from the first pipe stub 2. The second clamp body 15 radially and axially grips the second pipe stub 3 in the region of the flange 11 as well as the second pipe body 6 in the region of the compression 10 so that the second pipe body 6 is secured against becoming detached from the second pipe stub 3. For this the respective clamp body 14, 15 has a receiving structure 17 which is U-shaped in cross-section and is designed complementary to the associated pipe stub 2, 3 and pipe body 5, 6 in such a way that the receiving structure 17 pretensions the compression 10 axially against the pipe stub 2, 3 and thus secures the pipe body 5, 6 against becoming detached from the associated pipe stub 2, 3, wherein in the shown example the pre-tensioning takes place by way of ring seal 12 so that the pipe stub 2, 3 is sealed towards the outside. On the side of the receiving structure 17 facing away from the pipe stub 2 an axially spaced frame 18 adjoins which radially surrounds the associated pipe body 5.

From FIGS. 3 and 4 in particular it can be seen that the respective clamp body 14, 15 is U-shaped when viewed from above and has a long leg 19 as well as a short leg 20, wherein the long legs 19 of both clamp bodies 14, 15 are arranged on a first side 21 of the connecting body 16 and the short legs 20 of both clamp bodies 14, 15 are arranged on a second side 22 of the connecting body 16 facing away from the first side 21. It can also be seen that the clamp bodies 14, 15 and the connecting body 16 are arranged in a joint plane.

The connecting body 16 has a fixing device 23 which fixes the clamp bodies 14, 15 in an end pivot position 24 shown in FIGS. 1 and 2, so that the clamp bodies 14, 15 can no longer be moved, in particular pivoted, relative to each other. In the shown example the clamp bodies 14, 15 are open, pointing away from each other in the end pivot position 24.

The fixing device has first fixing element 25, radially projecting from the first clamp body 14 on the side facing away from the open side, which in the shown example is designed as a stem 26 and radially on one side has an axially projecting engagement structure 27, which in the shown example is in the form of an engagement nose 28. The fixing element 23 also has a second fixing element 29 which projects radially on the side of the second clamp body 15 facing away from the open side of the clamp body 15, where in the shown example the second fixing element 29 is designed as a seating 30. The first fixing element 25 and the second fixing element 29 of the fixing device 23 serve to fix the clamp bodies 14, 15 together in the end pivot position 24. In the shown example the engagement nose 28 engages in the seating 30 and forms a positively locked connection 31 in the form of an engagement connection 32 between the fixing elements 25, 29 so that the clamp bodies 14, 15 are secured against becoming undone from the end pivot position 24.

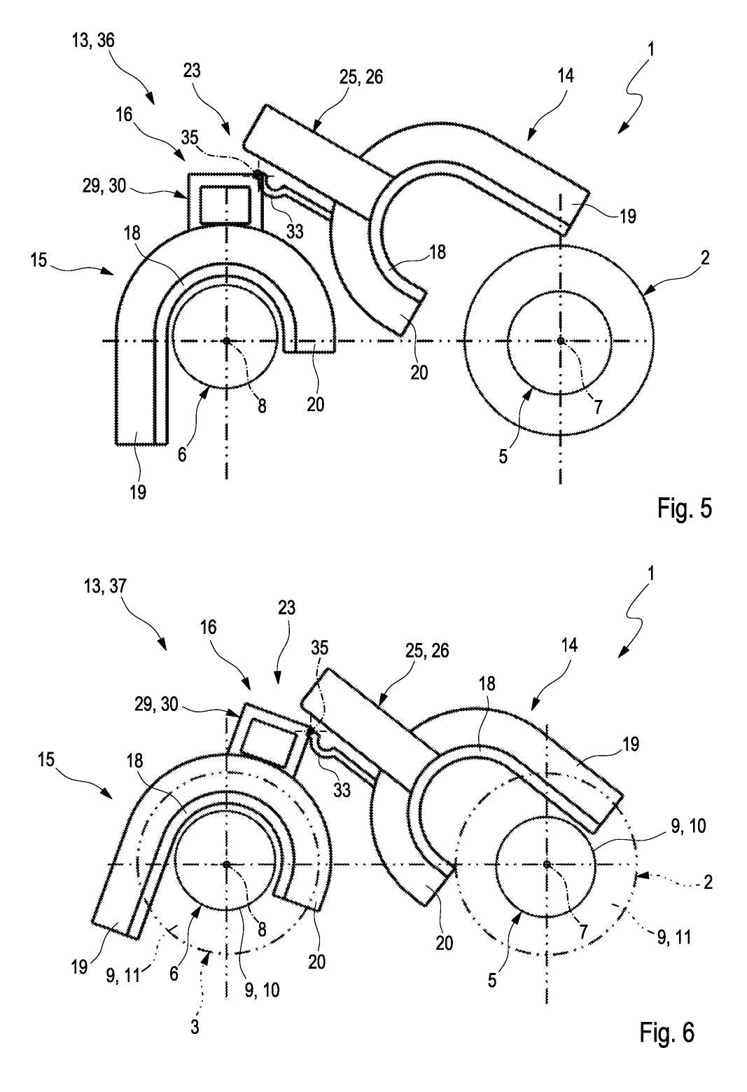

The connecting body 16 also has a hinge 33 which is applied on the second fixing element 20 and on a connecting element 34 projecting in parallel to the first fixing element 25 from the first clamp body 14. The hinge 33 allows pivoting of the clamp bodies 14, 15 relative to each other and defines a common pivoting axis 35 about which both clamp bodies 14, 15 clamp bodies 14, 15 are pivotable and which extends axially. In this way it is possible to pivot the connecting clamp 13 or the clamp bodies 14, 15 between the end pivot position 24 shown in FIGS. 1 and 2 and a start pivot position 36, which, in particular, depends on the initial shape of the hinge 33 and can be seen in FIG. 5.

FIGS. 5 to 9 show successive steps for applying the connecting clamp 13 to the associated pipe stubs 2, 3 as well as pipe bodies 5, 6. These figures each show a view from above, wherein the pipe stubs 2, 3 and the pipe bodies 5, 6 are illustrated in a greatly simplified manner and in parts with dashed lines.

In the first stage shown in FIG. 5 the second clamp body 15 is pushed onto or mounted on the second pipe stub 3 (not shown in FIG. 5) and the second pipe body 6 in such a way that the receiving structure 17 of the second clamp body 15 radially and in the circumferential direction surrounds the compression 10 of the second pipe body 6 and the flange 11 of the second pipe stub 3. If the second clamp body 15 is radially mounted on the second pipe stub 3 and the second pipe body 6, the second clamp body 15 can be rotated about the second longitudinal central axis 8 of the second pipe stub 3. At the same time the clamp bodies 14, 15 are pivotable relative to each other about the pivoting axis which extends in parallel to the longitudinal central axes 7, 8.

FIG. 6 shows a subsequent stage in which in comparison to the stage shown in FIG. 5 the second clamp body 15 is rotated about the second longitudinal central axis 8 so far until the long leg 19 of the first clamp body 14 is partially radially pushed onto or mounted on the first pipe stub 2 and the first pipe body 5 in such a way that the receiving structure 17 in this region of the long leg 19 of the first clamp body 14 takes up the compression 10 of the first pipe body 5 and the flange 11 of the first pipe stub 2.

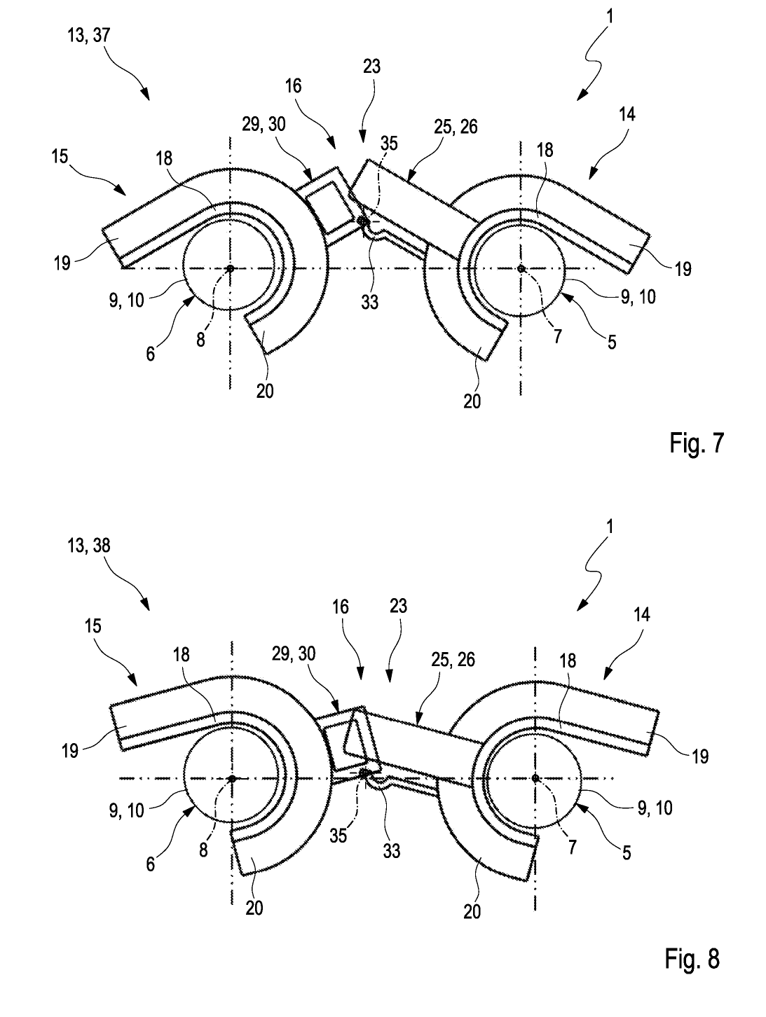

In the first stage shown in FIG. 7 the second clamp body 15 is rotated about the second longitudinal central axis 8 and the first clamp body 14 pivoted about the pivoting axis 35 in such a way that the connecting clamp 13 and/or the clamp bodies 14, 15 form an intermediate pivot position between the start pivot position 36 and the end pivot position 24. In this state the first clamp body 14 is radially fully mounted on the first pipe stub 2 and the first pipe body 5 in such a way that the receiving structure 7 of the first clamp body 14 radially and in the circumferential direction surrounds the compression 10 of the first pipe body 5 and the flange 11 of the first pipe stub 2. In this state the first clamp body 14 is rotatable about the first longitudinal central axis 7, while the second clamp body 15 is rotatable about the second longitudinal central axis 8. In addition the clamp bodies 14, 15 can be pivoted relative to each other about the pivoting axis 35. The clamp bodies 14, 15 are pivoted relative to each other in such a way that the first fixing element 25 moves in the direction of the second fixing element 29.

FIG. 8 shows a further intermediate pivot position 8 of the connecting clamp 13 and/or the clamp bodies 14, 15, which is also denoted as the second intermediate pivot position 38 in the following. In this state the two clamp bodies 14, 15 are rotated further about the associated longitudinal middle axes 7, 8 and pivoted further relative to each other about the pivot axis 35 in such a way that the engagement structure 27 or engagement nose 28 of the first fixing element 25 overlaps with the second fixing element 29 designed as a seat 30, wherein the first fixing element 25 in the form of a stem 26 is elastically deformed. The engagement 27 is arranged on the non-visible side of the first fixing element 25 and is therefore not shown.

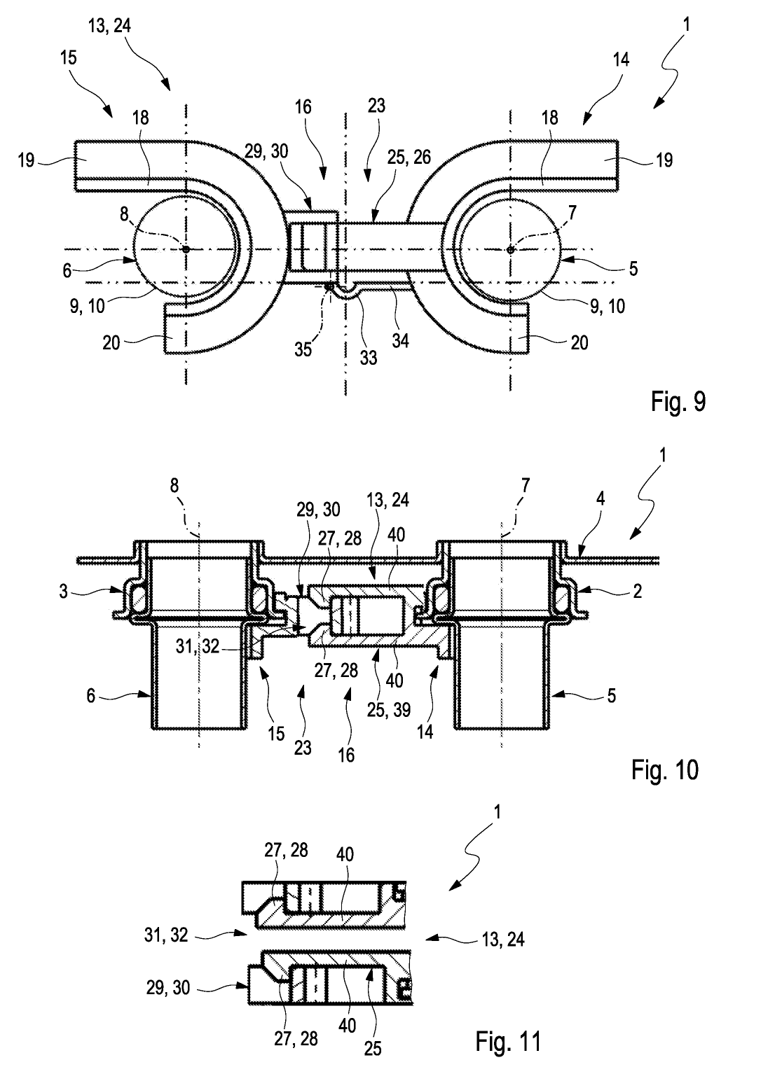

In FIG. 9 the end pivot position 24 of the connecting clamp 13 and/or the clamp bodies 14, 15 is shown. In the end pivot position 24 the engagement structure 27 is engaged in the second fixing element 29 in the form of a seat 30 so that the fixing elements 25, 29 form the positive locked connection 31 in the form of the engagement connection 32. In this way the fixing device 23 with the fixing element 25, 29 therefore fixes the clamp bodies 14, 15 in the end pivot position 24 in such a way that the clamp bodies 14, 15 can no longer be pivoted relative to each other. In addition, the clamp bodies 14, 15 can also no longer rotate about the longitudinal central axes 7, 8.

In the end pivot position 24 which can also be seen in FIGS. 1 and 2, the clamp bodies 14, 15 are open facing away from each other. In addition the first fixing element 25 in the form of a stem 26 extends radially with regard to both clamping element 14, 15. The same applies for the connecting element 34. The hinge 33 is also located radially centrally between the longitudinal central axes 7, 8.

Pivoting of the clamp bodies 14, 15 in the direction of the start pivot position 6 and therefore loosening of the connecting clamp 13 from the pipe stubs 2, 3 or pipe bodies 6, 7 is possible in that the engagement structure 27 is released from the engagement connection 32 through elastic deformation of the first fixing element 25.

In FIG. 10 the view in FIG. 2 is shown in the region of the pipe stubs 2, 3 wherein FIG. 10 shows a different example of embodiment. This example of embodiment differs from the previously described example of embodiment in that the first fixing element 25 is designed as a grip 39 which has two grip arms 40, wherein the grip arms 40 have projecting engagement structures 27, in particular engagement noses 28 facing each other, which in the end pivot position 24 each engage in the second fixing element 29 designed in the form of a seat 30 and thus form the positive locked connection 31 or engagement connection 32.

As shown in FIG. 11 it is also conceivable to provide the grip arms 40 of the first fixing element 25 with engagement structures 27 or engagement noses 28 which face away from each other and engage in the seat 30 and thus form the positive locking connection 31 or the engagement connection 32.

1. A connecting clamp for connecting two pipe stubs with an associated pipe body comprising:
a first clamp body for connecting a first pipe stub with a first pipe body and a second clamp body disposed spaced apart from the first clamp body for connecting a second pipe stub with a second pipe body; and
a connecting body arranged between the clamp bodies and pivotably connecting the clamp bodies with one another such that the clamp bodies are pivotable relative to one another between a start pivot position and an end pivot position;
wherein the connecting body includes a fixing device for fixing the clamp bodies in the end pivot position.

2. The connecting clamp according to claim 1, wherein a respective clamp body is radially pluggable onto an associated pipe stub and the respective clamp body is pivotable about an axially extending pivot axis.

3. The connecting clamp according to claim 1, wherein the connecting body defines a pivot axis, about which the clamp bodies are pivotable.

4. The connecting clamp according to claim 1, wherein:
the fixing device includes, arranged on the first clamp body, a first fixing element and, arranged on the second clamp body, a second fixing element; and
the fixing elements, when the clamp bodies are in the end pivot position, interact and fix the clamp bodies.

5. The connecting clamp according to claim 4, wherein the fixing elements, when the clamp bodies are in the end pivot position, are connected to one another via a positively locked connection such that the fixing elements secure the clamp bodies against a disengaging from the end pivot position.

6. The connecting clamp according to claim 1, wherein:
the clamp bodies are U-shaped and respectively include a long leg and a short leg; and
the long legs of the clamp bodies are arranged on a first side of the connecting body and the short legs of the clamp bodies are arranged on a second side of the connecting body facing away from the first side.

7. The connecting clamp according to claim 1, wherein the connecting body further includes a hinge pivotably connecting the clamp bodies with one another.

8. The connecting clamp according to claim 4, wherein the connecting body further includes a hinge pivotably connecting the clamp bodies with one another, the hinge attached on at least one of the fixing elements and pivotably connecting the clamp body attached to the at least one of the fixing elements with the other clamp body.

9. The connecting clamp according to claim 4, wherein the first fixing element is a stem projecting from the first clamp body with a projecting engagement structure and the second fixing element is a seating, and wherein the engagement structure, when the clamp bodies into are in the end pivot position, engages in the seating connecting the fixing elements in a positively locked manner.

10. The connecting clamp according to claim 1, wherein at least one of the clamp bodies has a U-shaped cross section for engaging about a section projecting radially outside of at least one of the associated pipe stub and the associated pipe body.

11. The connecting clamp according to claim 2, wherein the clamp bodies are arranged in a common plane, the pivot axis extending transversely to the common plane.

12. A heat exchanger comprising:
a first pipe stub and an associated first pipe body, and a second pipe stub and an associated second pipe body for a fluidic supply of the heat exchanger; and
a connecting clamp connect the pipe bodies with the respective associated pipe stub, the connecting clamp including:
a first clamp body configured to connect the first pipe stub with the first pipe body;
a second clamp body configured to connect the second pipe stub with the second pipe body, the second clamp body disposed spaced apart from the first clamp body; and
a connecting body arranged between the first clamp body and the second clamp body and pivotably connecting the first clamp body and the second clamp body to one another such that the first clamp body and the second clamp body are pivotable relative to one another to a start pivot position and an end pivot position, the connecting body including a fixing device configured to fix the first clamp body and the second clamp body in the end pivot position.

13. The heat exchanger according to claim 12, wherein the pipe stubs are arranged spaced apart from one another and parallel to one another.

14. The heat exchanger according to claim 12, wherein the first clamp body is rotatable about at least one of a longitudinal centre axis of the associated first pipe stub and an axis extending parallel thereto, and wherein the second clamp body is rotatable about at least one of a longitudinal centre axis of the associated second pipe stub and an axis extending parallel thereto.

15. The heat exchanger according to claim 12, wherein at least one of:
at least one of the pipe stubs includes a flange projecting radially outside against which the associated pipe body is abutable; and
at least one of the pipe bodies includes a compression projecting radially outside, the at least one of the pipe bodies abutable against the associated pipe stub via the compression.

16. The heat exchanger according to claim 12, wherein the first clamp body and the second clamp body are pivotable about an axially extending common pivot axis.

17. The heat exchanger according to claim 16, wherein the connecting body includes a hinge defining the common pivot axis and pivotably connecting the first clamp body and the second clamp body.

18. The heat exchanger according to claim 12, wherein at least one of the first clamp body and the second clamp body has a U-shaped cross section configured to engage about a section projecting radially outside of at least one of an associated pipe stub and an associated pipe body.

19. A connecting clamp comprising:
a first clamp body configured to connect a first pipe stub and a first pipe body;
a second clamp body configured to connect a second pipe stub and a second pipe body, the second clamp body disposed spaced apart from the first clamp body; and
a connecting body arranged between the first clamp body and the second clamp body including a hinge pivotably connecting the first clamp body and the second clamp body with one another such that the first clamp body and the second clamp body are pivotable relative to one another to a start pivot position and an end pivot position;
the connecting body further including a fixing device defined by a first fixing element arranged on the first clamp body and a second fixing element arranged on the second clamp body, the first fixing element and the second fixing element structured and arranged to interact with one another and fix the first clamp body and the second clamp body to one another when the first clamp body and the second clamp body are in the end pivot position.

20. The connecting clamp according to claim 19, wherein:
the first fixing element is a stem projecting from the first clamp body including a projecting engagement structure; and
the second fixing element is a seating, the engagement structure engaging the seating connecting the first fixing element and the second element in a positively locked manner when the first clamp body and the second clamp body are in the end pivot position.
